(19) United States
(12) Patent Application Publication
(10) Pub. No.: US 2021/0387280 A1
(43) Pub. Date: Dec. 16, 2021

(54) METHOD AND DEVICE FOR MONITORING A CUTTING PROCESS

(71) Applicant: TRUMPF Werkzeugmaschinen GmbH + Co. KG, Ditzingen (DE)

(72) Inventors: Steffen Kessler, Stuttgart (DE); David Schindhelm, Stuttgart (DE); Winfried Magg, Ditzingen (DE)

(21) Appl. No.: 17/286,976

(22) PCT Filed: Oct. 22, 2019
(86) PCT No.: PCT/EP2019/078679

§ 371 Date: Apr. 20, 2021

(30) Foreign Application Priority Data
Oct. 22, 2018 (DE) 10 2018 218 006.7

(51) Int. Cl. B23K 26/03; B23K 26/38

(52) U.S. Cl. CPC B23K 26/032; B23K 26/0648; B23K 26/38

(57) ABSTRACT

A method for monitoring, in particular for controlling, a cutting process on a workpiece, includes focusing a machining beam, in particular a laser beam, on the workpiece, detecting a region of the workpiece to be monitored, the region including an interaction region in which the machining beam interacts with the workpiece, and determining at least one characteristic variable of the cutting process, in particular of a kerf formed during the cutting process, on the basis of the detected interaction region. In a fusion cutting process, a cutting front length of a cutting front formed at the kerf is determined as a characteristic variable on the basis of the detected interaction region. A corresponding device for monitoring, in particular for controlling, a cutting process on a workpiece, is also provided.

The present invention relates to a method for monitoring, in particular for controlling, a cutting process on a workpiece, comprising: focusing a machining beam, in particular a laser beam, on the workpiece, detecting a region of the workpiece to be monitored, said region comprising an interaction region in which the machining beam interacts with the workpiece, and determining at least one characteristic variable of the cutting process, in particular of a kerf formed during the cutting process, on the basis of the detected interaction region. The invention also relates to a device for monitoring, in particular for controlling, a cutting process on a workpiece, comprising: a focusing unit for focusing a machining beam, in particular a laser beam, on the workpiece, an image acquisition unit for detecting a region to be monitored on the workpiece, said region comprising an interaction region of the machining beam with the workpiece, and an evaluation unit, which is designed, on the basis of the detected interaction region, to determine at least one characteristic variable of the cutting process, in particular of the kerf.

A device of the type mentioned at the outset for monitoring a laser cutting process, which can be used to detect characteristic variables of a laser cutting process, for example of an imminent incomplete cut, is known from WO 2012/107331 A1 of the applicant. An imminent incomplete cut is recognized therein if the gap width of the cutting gap falls below a predetermined gap width. Alternatively or additionally, the area of the observed cutting front is compared to a reference area, which corresponds to the area of the cutting front in a good cut or quality cut. An incomplete cut can also be detected if the radiation intensity emitted from the reference area exceeds a limiting value for the target brightness in a normal cut.

In addition, WO 2012/107331 A1 proposes detecting a cutting front upper edge and a cutting front lower edge as material boundaries and determining the cutting front angle of the laser cutting process therefrom taking into account the thickness of the workpiece. If the cutting front angle differs from a target value or a target range, this can indicate a cutting error or a non-optimal operating point, which can be corrected by suitable measures, for example by adapting the cutting speed.

The general cause of an incomplete cut is an insufficient introduction of energy into the workpiece. The excessively low energy per unit length results in flattening of the cutting front, i.e., an enlargement of the cutting front angle, whereby the melt can no longer be completely expelled at the cut lower edge and solidifies in the kerf. The closure of the cut lower edge results in process irregularities, which generally permanently prevent a severing cut. The cutting front angle, which represents a characteristic variable of the cutting gap, is therefore an indicator of an imminent incomplete cut.

In the observation of material boundaries, there is the problem in the case of coaxial process observation through the cutting nozzle that the observation region through the inner contour of the cutting nozzle, which is generally circular, is limited. In particular in flame cutting processes, small nozzle diameters are used, so that the cutting front lower edge is outside the observation region delimited by the nozzle orifice even in the case of a good cut and the cutting front angle cannot be reliably determined.

To solve this problem, WO2015036140A1 of the applicant proposes that inferences about the cutting front angle as a characteristic variable of the cutting process be drawn from a brightness or intensity value which is determined from an image of the interaction region recorded in trailing observation at an angle to the beam axis of the laser beam. By comparing the intensity value to a threshold value, it is possible to conclude that a critical value of the cutting front angle is exceeded, upon which there is no longer a good cut.

Detecting the upper and lower end of the cutting front using a camera arranged offset to the laser beam axis is known from WO2016181359A1, wherein the observation direction of the camera is oriented against the cutting direction to the rear into the cutting gap, so that the lower end of the cutting front can be detected. A cutting front lag is determined from the camera images, which can be regulated to a specific target value.

### OBJECT OF THE INVENTION

The invention is based on the object of providing a method and a device for monitoring, in particular for controlling, a cutting process, which enable reliable determination of a characteristic variable of the cutting process, in particular a characteristic variable of a kerf formed during the cutting process, and/or advantageous control of the cutting process.

### SUBJECT MATTER OF THE INVENTION

This object is achieved according to a first aspect by a method of the type mentioned at the outset, which is characterized in that, in a fusion cutting process, a cutting front length of a cutting front formed at the kerf is determined as a characteristic variable on the basis of the detected interaction region.

The inventors have recognized that a determination of the cutting front length as a characteristic variable of a fusion cutting process and possibly as a control variable for the fusion cutting process is possible by detecting the length of a light appearance from the process zone or the interaction region of the machining beam with the workpiece. A thermal image of the region to be monitored or of the interaction region is typically recorded for this purpose, i.e., the intrinsic light of the fusion cutting process, for example at wavelengths in the NIR/IR wavelength, is detected or observed, but an observation at other wavelengths is optionally also possible, for example in the UV wavelength range.

In one variant, the detection of the region to be monitored is carried out by means of an observation beam path extending essentially coaxially to a beam axis of the machining beam. An essentially coaxially extending observation beam path is understood to mean that the observation beam path extends coaxially or parallel to the beam axis or at a (small) angle to the beam axis of the machining beam of less than 5°. It has been shown that the detection of the light appearance by means of an observation beam path which extends essentially coaxially to the beam axis of the machining beam by a coaxial camera-based process observation is simpler to implement with respect to system technology than an off-axis arrangement of a location-resolving detector, for example a camera.

The region to be monitored is preferably detected through a nozzle opening of a machining nozzle for the passage of the machining beam onto the workpiece. The hot cutting front is imaged as process light by an imaging sensor system having a perpendicular or quasi-perpendicular (<5° angle to the beam axis of the machining beam or the laser beam) view through the machining nozzle, the length of the cutting front is measured, and the cutting process can if necessary be controlled to its (target) length (see below).

In one refinement, a nozzle opening of the machining nozzle, through which a cutting gas jet exits from the machining nozzle, has a maximum extension of at least 7 mm, preferably between 7 mm and 12 mm. A machining nozzle having a comparatively large nozzle opening is advantageous for controlled process guidance of the fusion cutting process, as described in greater detail below.

The maximum extension is understood in a machining nozzle having a circular cross section as the diameter of the nozzle opening. In the case of a different cross-sectional geometry of the nozzle, the maximum extension is understood as the longest nozzle axis of the nozzle opening. In a nozzle opening having elliptical cross section, the maximum extension is, for example, the length of the long nozzle axis. The maximum extension of the nozzle opening is measured on the side of the nozzle facing toward the workpiece.

In a further variant, the fusion cutting process is carried out at a cutting gas pressure of less than 10 bar, preferably greater than 1 bar and less than 10 bar, particularly preferably at least 2 bar and less than 6 bar. The cutting gas exits jointly with the machining beam from the nozzle opening of the machining nozzle and has the specified values for the cutting gas pressure upon the exit from the nozzle opening. The cutting gas used for the fusion cutting process is usually an inert gas, for example nitrogen, however gas mixtures having a certain oxygen component are also usable, for example.

As described in DE1 0201 6215019A1 of the applicant, at comparatively low cutting gas pressures in combination with comparatively large nozzle openings for the cutting gas jet, which enable good coverage of the kerf, a good edge quality can be achieved at significantly higher feed speeds than in previously typical fusion cutting high-pressure processes using cutting gas pressures of 10 to 25 bar.

In one variant, the fusion cutting process is carried out at a cutting speed which is at least 80%, preferably at least 90%, of an incomplete cut speed. The cutting speed of the fusion cutting process is therefore less than 20%, preferably less than 10% below the incomplete cut speed. The cutting quality remains good up to the incomplete cut limit, so that it is possible to cut using feed speeds close to the incomplete cut limit. In previously typical fusion cutting processes (standard processes) using nozzles having small diameters and using high cutting gas pressure, in contrast, the feed region up to the incomplete cut limit could not be fully utilized, since the quality of the cutting edge would worsen too strongly. The incomplete cut speed, i.e., the speed at which an incomplete cut occurs, can be (experimentally) determined beforehand in measurement series for different workpiece materials, workpiece thicknesses, and laser powers.

In one variant, the cutting front length is determined from an image of the interaction region as the length between two points along a profile section of the interaction region extending in the cutting direction, at which the brightness or intensity preferably falls below a brightness threshold value or an intensity threshold value, respectively. Along the length in the cutting direction between the two points, which form the front end or the rear end of the interaction region, the brightness of the light appearance in the image is thus greater than the brightness threshold value. The brightness or intensity threshold value can be defined, for example, relative to a reference value of the brightness or respectively intensity in the image. For example, a maximum intensity value within the image can be used as the reference value, to which the respective measured intensity is related or calibrated. Moreover, a calibration of the image detection unit can be carried out in a reference cutting process using reference cutting parameters and/or by comparing the intensity measured values to those of a reference image detection unit. The profile section, the length of which is used to determine the cutting front length, generally extends centrally inside the kerf.

In a further variant, the method comprises: controlling the cutting front length to a predetermined target length by influencing at least one adjustment parameter of the cutting process. In terms of this application, a control to a predetermined target length is understood to mean that a control to a constant target length takes place or the predetermined target length is prevented from being exceeded, i.e., the control prevents exceeding the target length.

The inventors have discovered that the cutting front length is suitable for control particularly at cutting speeds in the vicinity of the incomplete cut speed: In the previous standard processes for fusion cutting, in contrast, the cutting speeds are approximately 20-40% below the feeds, which are achieved in the case of the above-mentioned conditions with respect to the cutting gas pressure and the diameter of the nozzle opening. At the lower cutting speeds which are used in standard processes, the length of the light appearance or the cutting front length changes only slightly with suitable adjustment parameters of the cutting process, which influence the introduction of energy into the workpiece, for example, with the cutting speed (feed) or with the laser power, so that in standard processes the process control with the aid of these adjustment variable(s) or adjustment parameters is not advantageous.

In one refinement, the cutting speed between the machining beam and the workpiece (feed) and/or the power of the machining beam is/are influenced as adjustment parameters for controlling the cutting front length. The rise of the cutting front length with increasing feed becomes more and more pronounced with rising feed, so that a feed control (and accordingly also a control of the power of the machining beam) is possible in particular in the case of the above-described high cutting speeds, which are at least 80%, preferably at least 90% of the incomplete cut speed.

At these high cutting speeds, on the one hand, changing influencing variables, for example the soiling of a protective lens or the heating of the optical elements in the machining head, have a greater influence on the process result: An incomplete cut occurs more than in previous standard processes having higher cutting gas pressure, since the cutting process takes place closer to the incomplete cut limit. On the other hand, with these process conditions, the significant change of the measured length of the light appearance or the cutting front length as a function of the cutting speed (feed speed) and/or the laser power may be used as a good control variable employing the feed speed and/or the power of the machining beam as adjustment variable(s) or as adjustment parameters. An incomplete cut may be prevented in a simple manner via a change of the feed speed or the laser power, i.e., the fusion cutting process may be guided at sufficient distance to the incomplete cut again fast enough, which ensures the robustness of the process under interfering influences.

A further aspect of the invention relates to a device of the type mentioned at the outset, in which the evaluation unit is designed or programmed/configured to determine, on the basis of the detected interaction region as the characteristic variable, a cutting front length of a cutting front formed at the kerf. For this purpose, the evaluation unit can evaluate an image of the region to be monitored, which includes the interaction region and was recorded, for example through a nozzle opening of a machining nozzle, to determine the length of a light appearance in the cutting direction which corresponds to the cutting front length.

In one embodiment, the device comprises a control unit for controlling the cutting front length to a predetermined target length by influencing at least one adjustment parameter of the cutting process. The adjustment parameter influences the introduction of energy into the workpiece. The process can be controlled in particular by changing the cutting speed and/or the laser power, in such a way that the cutting front length determined by the evaluation unit corresponds to the target length or does not exceed the target length.

In one refinement, the control unit is designed or programmed/configured to control the cutting front length to a target length, at which the cutting speed is at least 80%, preferably at least 90% of an incomplete cut speed. As described above, the control of the cutting front length to the target length can be carried out using the cutting speed as the adjustment parameter if the cutting front length changes sufficiently strongly as a function of the cutting speed, which is the case in particular at high cutting speeds just below the incomplete cut speed.

Further advantages of the invention result from the description and the drawing. The abovementioned features and the still further features set forth can also be used as such or in multiples in any arbitrary combinations. The embodiments shown and described are not to be understood as an exhaustive list, but rather have exemplary character for describing the invention.

### IN THE FIGURES

FIG. 1 shows a schematic illustration of an exemplary embodiment of a device for monitoring and controlling a laser cutting process,

FIG. 2 shows an illustration of an image recorded using an image detection unit of a region to be monitored of the workpiece, on the basis of which a cutting front length is determined as a characteristic variable of the cutting process, and

FIG. 3 shows an illustration of the cutting front length as a function of the ratio of the cutting speed to an incomplete cut speed.

In the following description of the drawings, identical reference signs are used for equivalent or functionally equivalent components.

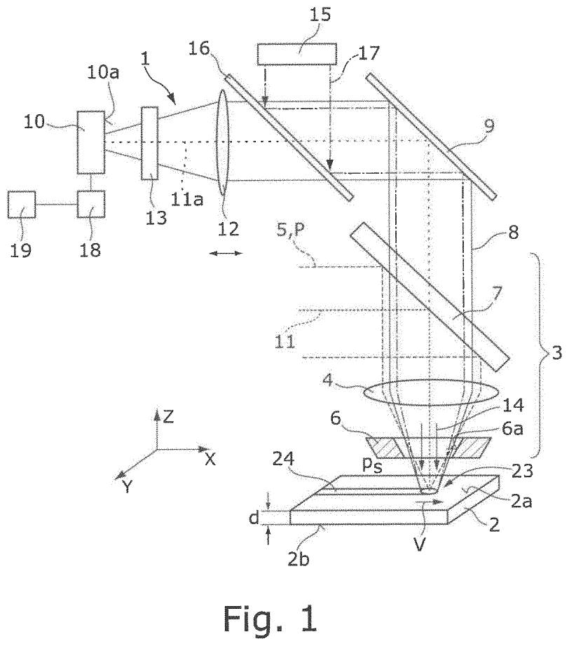

FIG. 1 shows an exemplary structure of a device 1 for process monitoring and control of a laser fusion melting process on a plate-shaped workpiece 2 by means of a laser machining system, of which only a machining unit 3 (part of a laser machining head) having a focusing lens 4 for focusing a 002, solid-state, or diode laser beam 5 of the laser machining system, a machining nozzle 6, and having a deflection mirror 7 is shown in FIG. 1. In the present case, the deflection mirror 7 is made partially transmissive and therefore forms an entry-side component of the device 1 for process monitoring. The device 1 for process monitoring is, like the machining unit 3, part of the laser machining head.

The deflection mirror 7 reflects the incident laser beam 5 and transmits the process radiation, which is relevant for the process monitoring and reflected from the workpiece 2 and which is emitted from the interaction zone, in a wavelength range which in the present example is between approximately 550 nm and 2000 nm. Alternatively to the partially transmissive deflection mirror 7, a scraper mirror or a perforated mirror can also be used to supply the process radiation to an observation beam path 8. However, the use of a scraper mirror typically results in suppression of a part of the process radiation and limiting of the raw beam diameter. The use of a perforated mirror generally results in diffraction effects of the process radiation and a strong influence of the laser radiation.

In the device 1, a further deflection mirror 9 is arranged behind the partially transmissive mirror 7, which deflects the process radiation onto a geometrically high-resolution camera 10 as the image acquisition unit. The camera 10 can be a high-speed camera, which is arranged coaxially to the laser beam axis 11 or to the extension 11a of the laser beam axis 11 and thus directionally independent. The observation beam path 8 in the example shown accordingly also extends coaxially to the laser beam axis 11 or to its extension 11a. In principle, there is the option of recording the image by way of the camera 10 in the incident light method, i.e., in the VIS wavelength range, possibly also in the NIR wavelength range, if an additional illumination source 15 is provided, which emits in the NIR range and couples illumination radiation 17 into the beam path coaxially to the laser beam axis 11 via a further partially transmissive mirror 16. As an additional illumination source 15, laser diodes, for example having a wavelength of 658 nm, or diode laser, for example having a wavelength of 808 nm, can be provided, which can be arranged coaxially as shown in FIG. 1, or also off-axis to the laser beam axis 11. Alternatively, recording the process intrinsic light in the wavelength ranges UV and NIR/IR without additional illumination is possible.

For improved imaging, an imaging focusing optical system 12, which is shown as a lens in FIG. 1 and which focuses the radiation relevant for the process monitoring on the camera 10, is provided in the present example between the partially transmissive mirror 7 and the camera 10. Spherical aberrations in the imaging can be prevented or at least reduced by an aspheric design of the imaging optical system or the lens 12 for focusing.

In the example shown in FIG. 1, a filter 13 in front of the camera 10 is advantageous if further radiation or wavelength components are to be excluded from the detection by the camera 10. The filter 13 can be designed, for example, as a narrowband bandpass filter having low full width at half maximum, to avoid or reduce chromatic aberrations. The location of the camera 10 and of the imaging optical element 12 provided in the present example and/or of the filter 13 along the laser beam axis 11 is settable and changeable if needed via a positioning system known to a person skilled in the art, which is illustrated by a double arrow for simplification.

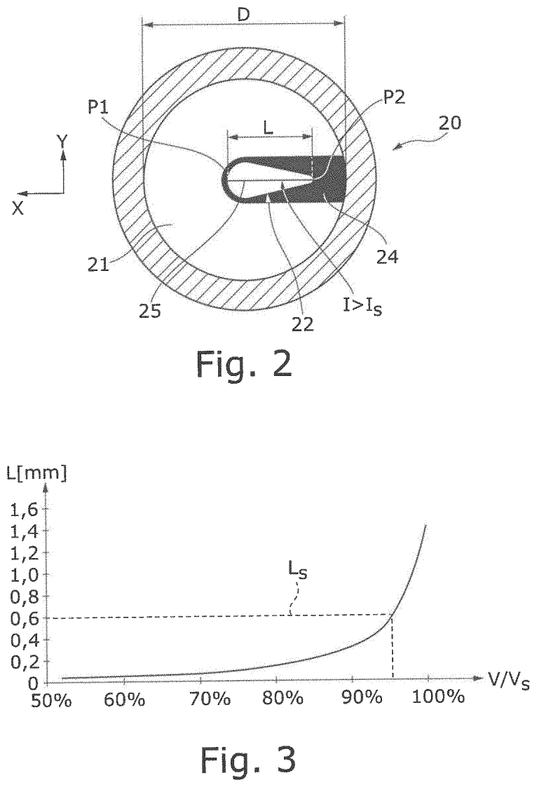

The camera 10 is operated in the present example without the additional illumination source 15, i.e., the intrinsic light of the process zone in the N IR/IR wavelength is detected. As shown in FIG. 2, the camera 10 records on its sensor surface 10a a high-resolution image 20 of a region 21 to be monitored (detail) of the workpiece 2. The image 20 is delimited by the circular inner contour of the nozzle opening 6a (cf. FIG. 1) of the nozzle 6, the diameter D or the maximum extension of which at the exit-side end of the nozzle 6 is between 7 mm and 12 mm in the example shown. The cutting process shown in FIG. 1 is a fusion cutting process using nitrogen as the cutting gas. The nitrogen exits as the cutting gas jet 14 from the nozzle opening 6a of the machining nozzle 6 at a comparatively low cutting gas pressure ps of less than approximately 10 bar, preferably of greater than 1 bar and less than 10 bar, ideally of greater than 2 bar and less than approximately 6 bar.

Alternatively to the example shown in FIG. 2, the nozzle 6 can also be formed as a ring flow nozzle having two (typically concentric) nozzle openings: The laser beam 5 then exits through the opening of the inner nozzle and the cutting gas jet 14 exits through the outer nozzle opening or through the inner and outer nozzle openings. In this case, the outer nozzle opening has a diameter or a maximum extension of at least 7 mm. The image recording of the camera 10 takes place through the inner nozzle opening, so that the image 20 is delimited by the circular inner contour of the inner nozzle opening, which has a diameter of, for example, 3 mm.

An evaluation unit 18 shown in FIG. 1 is used to evaluate the image 20 and in particular to detect an interaction region 22 within the region 21 to be monitored of the workpiece 2. The evaluation unit 18 has a signaling connection to a control unit 19 (also shown in FIG. 1), which controls or regulates the laser cutting process, and does so as a function of a characteristic variable of the laser cutting process determined by the evaluation unit 18, which variable is a cutting front length L of a cutting front 23 (cf. FIG. 1) formed during the cutting machining, on which a kerf 24 adjoins against a feed or cutting direction (i.e., in the negative X direction). As can be seen in FIG. 2, the cutting front length L is measured between a point P1 at the front end of the interaction region 22 and a point P2 at the rear end of the interaction region 22 along the feed or cutting direction, along which the laser beam 5 is guided over the workpiece 2 at a cutting or feed speed V (cf. FIG. 1). In the example shown, the feed direction corresponds to the X direction.

To determine the cutting front length L, rapid image recording can take place during the cutting process with the aid of the image acquisition unit 10, for example at a frequency of 100-1000 Hz. The individual images 20 are evaluated, for example, by a threshold value method, i.e., binarization of a respective image 20 is carried out by comparing the intensity values of the recorded light appearance at the individual pixels to a threshold value. The length of the light appearance in the cutting direction (X direction) is determined from the binarized image 20, which corresponds to the cutting front length L. The cutting front length L can thus be determined from the image 20, for example, via brightness threshold values Is of a profile section 25 of the light appearance extending in the cutting direction (X direction), i.e., the cutting front length can be determined as the length L between two points P1, P2 of the profile section 25, at which the brightness falls below a predetermined brightness threshold value Is or predetermined brightness threshold values. A calibration of the measured values of the intensity I to a reference value within the image 20, for example to a maximum intensity value of the image 20, can be carried out. Moreover, a calibration of the image acquisition unit 10 can be carried out in a reference cutting process to reference cutting parameters and by comparison of the measured values to those of a reference image acquisition unit.

Further relevant process parameters in addition to the cutting gas pressure ps, the diameter D of the machining nozzle 6, and the cutting speed V are the laser power P of the laser beam 5 or the laser source (not shown in the figures), the material of the workpiece 2, and the thickness d of the plate-shaped workpiece between an upper side 2a and a lower side 2b of the workpiece 2.

The further above-described fusion cutting process can be carried out, for example, using the following process parameters:

Structural steel:

d=4 mm, P=10 kW, V=20 m/min, ps=7 bar

d=10 mm, P=10 kW, V=5 m/min, ps=9 bar

Stainless steel:

d=4 mm, P=10 kW, V=21 m/min, ps=6 bar

d=10 mm, P=10 kW, V=5.5 m/min, ps=4 bar

Aluminum:

d=4 mm, P=10 kW, V=35 m/min, ps=8 bar

d=10 mm, P=10 kW, V=8 m/min, ps=9 bar

In a fusion cutting process, which is carried out under the above-described conditions, i.e., with a comparatively low cutting gas pressure ps and a large diameter D of the machining nozzle 6, a good edge quality of the kerf 24 can be achieved even at high cutting speeds V. The good cutting quality is maintained in particular even at cutting speeds V which are close to the incomplete cut speed Vₛ, i.e., the fusion cutting method can also be carried out at high cutting speeds V which are at least 80%, preferably at least 90% of an incomplete cut speed Vₛ. The incomplete cut speed Vs can be determined beforehand in measurement series for a respective workpiece material, a respective workpiece thickness d, a predetermined laser power P, and a predetermined cutting gas pressure pₛ. The corresponding values for the incomplete cut speed Vs can be stored, for example, in technology tables or the like in a storage unit, which can be arranged in the evaluation unit 18 or at another location.

At high cutting speeds V close to the incomplete cut speed Vₛ, an incomplete cut is more likely to occur than in previous standard processes, which are carried out at higher cutting gas pressure ps and lower cutting speeds V. In the event of an imminent incomplete cut, the cutting front length L increases strongly, so that it is favorable to control the cutting front length L with the aid of the control unit 19 to a predetermined, constant target length Lₛ. To achieve this, the control unit 19 influences or changes at least one adjustment parameter of the cutting process, which influences the introduction of energy into the workpiece 2.

FIG. 3 shows the dependence of the cutting front length L determined with the aid of the evaluation unit 18 on the cutting speed V, more precisely on the ratio of the cutting speed V to the incomplete cut speed Vₛ, for the example of structural steel having a thickness d of the workpiece of 2 to 8 mm. As can be seen in FIG. 3, the rise of the cutting front length L becomes more and more pronounced with rising cutting speed V, so that a control of the cutting front length L with the aid of the cutting speed V or the feed as adjustment parameter is possible at high cutting speeds V, which are typically greater than 80% or greater than 90% of the incomplete cut speed Vₛ.

In the example shown in FIG. 3, the target length Lₛ of the cutting front length L is approximately 0.6 mm, which corresponds to a ratio of the cutting speed V to the incomplete cut speed Vs of approximately 95%. A control of the cutting front length L to a predetermined target length Lₛ can alternatively or additionally also be carried out with the aid of the laser power P of the laser beam 5 as the adjustment parameter. In both cases, the fusion cutting process can be guided with a sufficient distance from the incomplete cut by the influencing of the introduction of energy, which ensures the robustness of the fusion cutting process under interfering influences.

If the cutting speed V or the feed is used as the adjustment parameter for the control, the feed specification or the feed adjustment ΔV (change of the cutting speed V) can take place in a regular cycle (for example 200 Hz). The feed adjustment ΔV can be formed, for example, from the present speed V, which is stored in the control unit 19 or in the evaluation unit 18, the target length Lₛ, the difference ΔL between the cutting front length L presently measured by the evaluation unit 18 and the target length Lₛ, and a (constant) proportionality factor f according to the following formula:

ΔV/V=f*ΔL/Lₛ.

The control of the cutting front length L to the target length Lₛ can be carried out on the basis of the individual images, if it takes place slowly enough (for example at a clock rate of 200 Hz), so that a good control behavior without overshoots is obtained. Averaging of the individual images 20 recorded by means of the image acquisition unit 10 can make the image processing, i.e., the determination of the cutting front length L, more robust. A sliding, possibly weighted mean value can be determined for the averaging. For example, the averaging can be carried out in that a current image and the last mean value image are combined using a predetermined weighting to form a new mean value image: for example, 30% current image +70% old mean value image=new mean value image.

In the above-described way, the fusion cutting process can be carried out close to the incomplete cut speed Vₛ, i.e., the feed range up to the incomplete cut speed Vₛ can be nearly fully utilized, without the quality of the cut edges of the kerf 24 worsening or an incomplete cut occurring.

1-12. (canceled)

13. A method for monitoring or controlling a cutting process on a workpiece, the method comprising:
focusing a machining beam or a laser beam on the workpiece;
detecting a region of the workpiece to be monitored, the region including an interaction region in which the machining beam interacts with the workpiece; and
in a fusion cutting process, determining, based on the detected interaction region, a cutting front length of a cutting front formed at a kerf during the cutting process, as a characteristic variable of the cutting process.

14. The method according to claim 13, which further comprises using an observation beam path extending coaxially to a beam axis of the machining beam for detecting the region to be monitored.

15. The method according to claim 13, which further comprises providing a nozzle opening of a machining nozzle for passage of a cutting gas jet with a maximum extension of at least 7 mm.

16. The method according to claim 15, which further comprises providing the maximum extension to be between 7 mm and 12 mm.

17. The method according to claim 13, which further comprises carrying out the fusion cutting process at a cutting gas pressure of less than 10 bar.

18. The method according to claim 13, which further comprises carrying out the fusion cutting process at a cutting gas pressure of greater than 1 bar and less than 10 bar.

19. The method according to claim 13, which further comprises carrying out the fusion cutting process at a cutting gas pressure of at least 2 bar and less than 6 bar.

20. The method according to claim 13, which further comprises carrying out the fusion cutting process at a cutting speed which is at least 80% of an incomplete cut speed.

21. The method according to claim 13, which further comprises carrying out the fusion cutting process at a cutting speed which is at least 90% of an incomplete cut speed.

22. The method according to claim 13, which further comprises determining the cutting front length from an image of the interaction region as a length between two points along a profile section of the interaction region extending in a cutting direction.

23. The method according to claim 22, which further comprises defining the two points as points at which a brightness falls below a brightness threshold value.

24. The method according to claim 13, which further comprises controlling the cutting front length to a predetermined target length by influencing at least one adjustment parameter of the cutting process.

25. The method according to claim 24, which further comprises influencing at least one of a cutting speed between the machining beam and the workpiece or a power of the machining beam, as adjustment parameters for controlling the cutting front length.

26. A device for monitoring or controlling a cutting process on a workpiece, the device comprising:
a focusing unit for focusing a machining beam or a laser beam on the workpiece;
an image acquisition unit for detecting a region to be monitored on the workpiece, the region to be monitored including an interaction region of the machining beam with the workpiece; and
an evaluation unit configured to determine, based on the detected interaction region, a cutting front length of a cutting front formed at a kerf during the cutting process, as a characteristic variable of the cutting process.

27. The device according to claim 26, which further comprises a control unit for controlling the cutting front length to a predetermined target length by influencing at least one adjustment parameter of the cutting process.

28. The device according to claim 27, wherein said control unit is configured to control the cutting front length to the target length, at which a cutting speed (V) is at least 80% of an incomplete cut speed.

29. The device according to claim 27, wherein said control unit is configured to control the cutting front length to the target length, at which a cutting speed is at least 90% of an incomplete cut speed.
